(19) United States
(12) Patent Application Publication
(10) Pub. No.: US 2026/0039466 A1
(43) Pub. Date: Feb. 5, 2026

(54) OPTIMIZING MAKEHINT ON A HARDWARE PLATFORM

(71) Applicant: Microsoft Technology Licensing, LLC, Redmond, WA (US)

(72) Inventors: Naga Kiranmayee UPADHYAYULA, Snohomish, WA (US); Mojtaba BISHEH NIASAR, Durham, NH (US); Bharat S. PILLILLI, El Dorado Hills, CA (US)

(21) Appl. No.: 18/792,328

(22) Filed: Aug. 1, 2024

(51) Int. Cl. H04L 9/30

(52) U.S. Cl. CPC H04L 9/3093

(57) ABSTRACT

A lattice-based cryptographic engine includes a MakeHint unit to generate hints for polynomial coefficients. Logic hardware is coupled to the MakeHint unit and includes a hint sum unit configured to add hints for coefficients of a polynomial, compare a hint sum to a threshold, and generate an invalid signal in response to the hint sum exceeding the threshold. The logic hardware also includes a sample buffer configured to receive the hints, a hint bitpack coupled to store indices of non-zero hints, and a controller coupled to control transfer of hints to output registers.

### BACKGROUND

The advent of quantum computers poses a serious challenge to the security of the existing public-key cryptosystems, as they can potentially be broken based on Shor's algorithm. Lattice-based cryptosystems are among the most promising post quantum computing (PQC) algorithms that are believed to be hard to crack for both classical and quantum computers.

A UseHint function reconstructs a signer's commitment by updating an approximate computed value labeled as w′ by utilizing a provided hint. There are significant efficiency and performance challenges in designing lattice-based cryptosystems implementing hint related functions.

### SUMMARY

A lattice-based cryptographic engine includes a MakeHint unit to generate hints for polynomial coefficients. Logic hardware is coupled to the MakeHint unit and includes a hint sum unit configured to add hints for coefficients of a polynomial, compare a hint sum to a threshold, and generate an invalid signal in response to the hint sum exceeding the threshold. The logic hardware also includes a sample buffer configured to receive the hints, a hint bitpack coupled to store indices of non-zero hints, and a controller coupled to control transfer of hints to output registers.

### BRIEF DESCRIPTION OF THE DRAWINGS

FIG. 1 is a block flow diagram of an example MakeHint unit to implement a Dilithium algorithm to compute h=MakeHint according to an example embodiment.

FIG. 2 is a block flow diagram of an improved MakeHint unit that utilizes only one decompose operation according to an example embodiment.

FIG. 3 is a diagram illustrating a parallel implementation of the improved MakeHint unit according to an example embodiment.

FIG. 4 illustrates embedded logic at into a Makehint unit to generate outputs required for signature generation according to an example embodiment.

FIG. 5 is a block diagram of a Decompose and W1Encode system used in signing operations according to an example embodiment.

FIG. 6 is a block diagram of an example Keccak unit for generating polynomial coefficients for lattice-based cryptographic systems according to an example embodiment.

FIG. 7 is a block diagram of an improved system configurable to perform both a signature verifying operation with parallel UseHint units according to an example embodiment.

FIG. 8 is a block diagram of a system for performing signing functions according to an example embodiment.

FIG. 9 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Lattice-based cryptosystems are among the most promising PQC algorithms that are believed to be hard for both classical and quantum computers.

An improved decompose/W1Encode system enhances efficiency of design from resource-sharing perspective. The improved system addresses efficiency and performance challenges in designing lattice-based cryptosystems by matching hardware functional components to a memory configuration.

An improved hardware-based system has an efficient architecture for an optimized MakeHint unit. The system uses fewer hardware resources and provides an output in a specific pattern that is useful for further operations in a high performance post quantum computing lattice based cryptographic system. The improved system efficiently leverages a

Decompose/W1Encode structure for a UseHint operation. The system uses a unified architecture that supports all required keygen, signing, and verifying operations for ML-DSA (Module Lattice Digital Signature Algorithm). By employing resource sharing strategies, the system minimizes overall resource consumption and improves efficiency. The system can be optimized and mapped to field programmable gate array (FPGA) and application specific integrated circuit (ASIC) platforms to develop highly efficient post quantum computing (PQC) cryptographic systems.

An improved MakeHint hardware device is first described followed by a description of embedded logic to generate required outputs for signatures. These descriptions are followed by a description of a resource sharing method with corresponding hardware.

### Improved MakeHint Device

A MakeHint unit is used for enabling the compact and secure construction of lattice-based digital signatures. Hint refers to a small carry bit hint vector that is part of the signature. The MakeHint unit is a fundamental building block in PQC module-lattice-based digital signature standard (ML-DSA). The Hint is generated in a signer side device and is used during a verification process, also by the signer side device, to ensure the integrity and authenticity of the signature. Optimizing a decomposition process is helpful for achieving faster signing times.

To reduce the size of a public key, algorithms are used to extract higher order and lower order bits. The goal is that when given an arbitrary element r of the key and another small element z of the key, the higher order bits should be resolvable without needing to store z. The hint is one bit that allows computation of the higher order bits of r+z just using r and h. This hint is essentially the “carry” caused by z in an addition.

The MakeHint unit uses a hardware platform with efficient architecture that lowers hardware resources needed and provides an output in a specific pattern that is useful for a high-performance PQC architecture.

The MakeHint unit architecture addresses efficiency and performance challenges in designing lattice-based cryptosystems.

A Dilithium signature scheme is an advanced cryptographic protocol based on lattice-based cryptography, resulting in a digital signature that is secure against quantum computer attacks. Within Dilithium, polynomials are represented in a specific ring, denoted as Zq[X]/(X\hat{ }n+1). Here, Zq represents integers modulo q, and X is the indeterminate variable.

The Dilithium public key is (p, t) and its size is dominated by t. Hence, to compact the public key, t is decomposed to two parts as (t1, t0), and the lower bits of polynomial t is not included in the public key. On the other side, a verifier cannot always correctly compute verifying checks since it includes the high-order bits of Az-ct.

Therefore, the signer includes some hints as part of the signature, which are essentially the carries caused by adding in the product of c with the missing low-order bits of t. With this hint, the verifier can correctly compute verifying checks.

Dilithium scheme defines the MakeHint and UseHint routines that produce a hint and, respectively, use the hint to recover the high-order bits of the sum.

The basic approach of the MakeHint (z, r) function involves decomposing both r and r+z into two parts: (r1, r0) for r and (rz1, rz0) for r+z. It then proceeds to evaluate whether r1 and rz1 are identical. In the event that r1 does not match rz1, it indicates that a hint is necessary to proceed. This process is used for determining when additional information is required to resolve discrepancies between the compared segments.

However, the decompose function implementation is expensive to implement in hardware. Furthermore, performing a sequential decompose function using a shared hardware resource requires more latency.

The process of implementing the decompose function is notably resource-intensive and can incur significant costs when executed on hardware. Additionally, the sequential execution of this function, particularly when it relies on a common hardware resource, tends to introduce increased latency. This is due to the fact that shared resources often necessitate additional time to manage concurrent operations, which can result in delays and reduced efficiency.

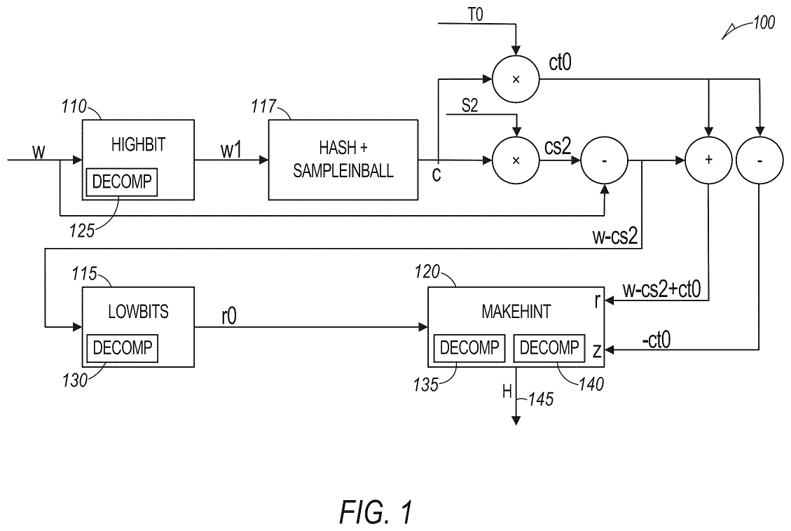

FIG. 1 is a block flow diagram of an example MakeHint unit 100 to implement the Dilithium algorithm to compute h=MakeHint (−ct0, w−cs2+ct0). Coefficients, w, are broken into HighBits 110 and Lowbits 115, with a hash and SampleInBall 117 operation performed on the HighBits 110. There are several decompose operations embedded into processing of the HighBits 110 and LowBits 115, as well as a MakeHint 120 function. The corresponding decompose operations are shown at 125, 130, 135, and 140, corresponding to four decompose operations to compute h. When h=0, no information is lost. If h=1 at output 145, information was lost. There are 256 coefficients in one polynomial, with each coefficient containing 23 bits. The operation is repeated for eight polynomials. The overhead of the four decompose operations is significant.

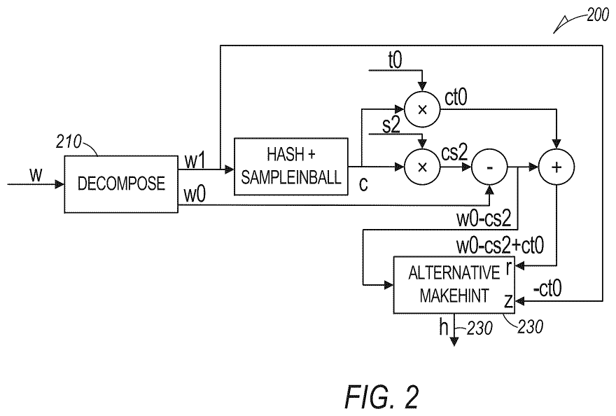

FIG. 2 is a block flow diagram of an improved MakeHint unit 200 that utilizes only one decompose operation 210 used to decompose w into high bits w1 and low bits WO. The improved MakeHint unit 200 utilizes an alternative MakeHint unit 220 to provide hint h on hint output 230.

To compute h=MakeHint(−ct0, w−cs2+ct0), first note is that instead of computing (r1, r0) =Decompose q (w−cs2, α) and checking whether ∥γ0∥_{∞}<γ₂−β and r1=w1, it is equivalent to just check that ∥w₀−cs₂∥₂₈<γ₂−β, where w0 is the low part of w. If this check passes, w0−cs2 is the low part of w−cs2.

By the definition of the MakeHint function, a coefficient of a polynomial in h as computed is non-zero precisely if the high parts of the corresponding coefficients of w−cs2 and w−cs2+ct0 differ. The full decomposition w=αw1+w0 of w has been computed, and it is known that αw1+(w0−cs2) is the correct decomposition of w−cs2. But then, αw1+(w0−cs2+ct0) is the correct decomposition of w−cs2+ct0 (i.e. the high part is w1) if and only if each coefficient of w0−cs2+ct0 lies in the interval (−γ2, γ2], or, when some coefficient is −γ2 and the corresponding coefficient of w1 is zero.

The last condition is due to the border case in the decompose function. On the other hand, if these conditions are not true, then the high parts must differ, and it then follows that for computing the hint vector h it suffices to just check these conditions on the coefficients of w0−cs2+ct0.

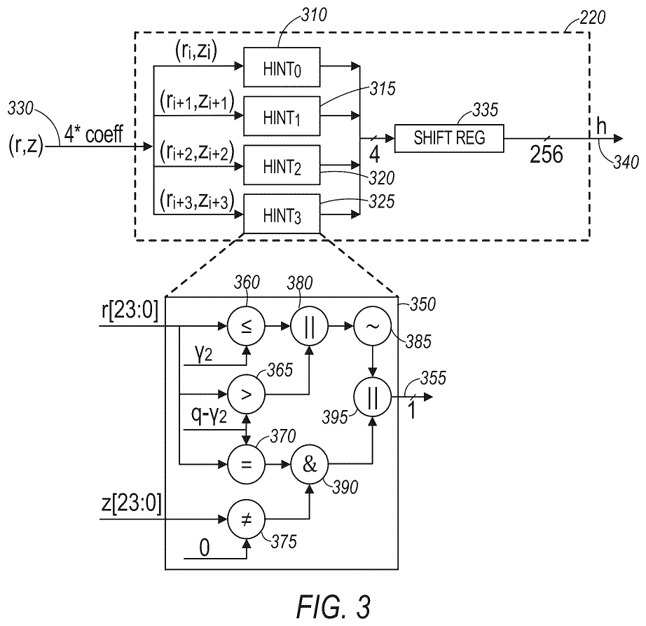

FIG. 3 is a diagram illustrating a parallel implementation of the improved MakeHint unit 220. MakeHint unit 220 reduces the decompose cost by modifying the MakeHint function to enhance efficiency over unit 100. MakeHint unit 220 receives a different r and z than MakeHint unit 145 at least due to the use of decompose 210 on w. MakeHint unit 220 includes four parallel MakeHint units 310, 315, 320, and 325, each receiving portions of coefficients 330. Outputs of the MakeHint units are provided to a shift register 335. Shift register 335 provides the hint, h at hint output 340.

MakeHint unit 325 is shown in further detail at 350, which also represents each of the parallel MakeHint units. The MakeHint unit includes multiple logic gates that receive r,z components of the polynomial coefficients and performs logic to determine whether or not information is lost, which is represented as a 1 bit output, corresponding to a portion of h at output 355.

The logic gates include a less than or equal to gate 360, greater than gate 365, and equal to gate 370 that each receive r. A not equal logic gate receives z. Results from gates 360 and 365 are provided to a or logic gate 380 with the result provided to a not logic gate 385. Outputs of the equal gate 370 and not equal gate 375 are provided to an and gate 390. The results of the not gate 385 and and gate 390 are provided to an or logic gate 395 which provides the hint at output 355.

Improved MakeHint unit 200 enables cascading of memory into the MakeHint unit that leads to better performance with less resource utilization. MakeHint unit 200 can be optimized and mapped to FPGA and ASIC platforms to develop highly efficient PQC architecture.

### Embedding HintSum and Hint Bitpack to Generate Required Outputs for Signatures

In Dilithium signing algorithm, the output of the MakeHint unit 200 (hint output) is further processed to generate an encoded ‘h’ component of the signature. Additionally, one of the validity checks in a signing algorithm uses hint sum to determine validity of the generated signature. These post-processing steps can be embedded into the MakeHint architecture to avoid latency overhead while maintaining low complexity.

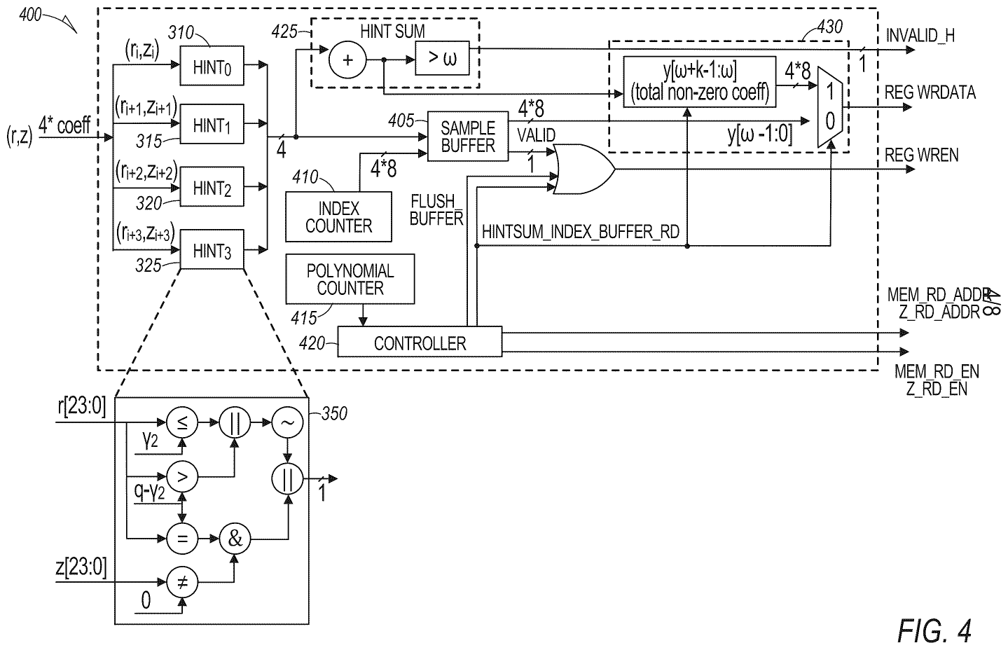

FIG. 4 illustrates embedded logic at 400 into MakeHint unit 200 to generate outputs required for signature generation. Four hints are generated every cycle, they are accumulated in a sample buffer 405 every cycle for all 8 polynomials. An index counter 410 is used to track an index count and a polynomial counter 415 keeps track of the current polynomial being processed. A controller 420 is used to control operation of the embedded logic 400 including flushing of the sample buffer 405.

A Hint Sum 425 is used to determine a sum of the hint values. Logic implemented by Hint Sum 425 is:

$$\{ \begin{matrix}if hintsum > ω & invalid\_h = 1 \\ else & invalid\_h = 0\end{matrix}$$

A Hint BitPack 430 is coupled to receive information from the Hint Sum 425 to provide an output that is a byte string ‘y’ of which [ω−1:0] bytes are the indices at which the generated hint is non-zero. [w+k−1:ω] bytes are the number of non zero coefficients from the first polynomial so far at which the hint is non-zero. If the number of non-zero hints is <ω, the rest of the entries of y are filled with Os. If the number of non-zero hints is >ω at Hint Sum, MakeHint flow continues for the remaining coefficients and the ‘y’ array is overwritten with the subsequent values. In this case, the ‘h’ component is invalid at output 430 and the signature is discarded and needs to be recalculated. w is a threshold value that is set to 75 in one example for 256 coefficients. Counts greater than ω mean that the signature cannot be verified. Once w is reached, calculations continue to protect against side channel attacks.

The following table shows an example of construction of a y array per polynomial based on generated hints.

| | | Index[3:0] | |
|---|---|---|---|
| Polynomial | Hint[3:0] | [7:0] | γ[ω-1:0] |
| 0 | 1-1-0-0 | 3-2-1-0 | 3-2 |
| 0 | 0-1-0-1 | 7-6-5-4 | 6-4-3-2 |
| 0 | 0-0-1-0 | 11-10-9-8 | 9-6-4-3-2 |
| . . . | . . . | . . . | . . . -9-6-4-3-2 |
| 1 | 1-1-1-0 | 3-2-1-0 | 3-2-1- . . . -9-6-4-3-2 |
| 1 | 0-1-1-0 | 7-6-5-4 | 6-5-3-2-1- . . . -9-6-4-3-2 |
| . . . | . . . | . . . | . . . -6-5-3-2-1- . . . -9-6-4-3-2 |
| 2 | 0-0-0-0 | 3-2-1-0 | . . . -6-5-3-2-1- . . . -9-6-4-3-2 |
| 2 | 0-0-0-1 | 7-6-5-4 | 4- . . . -6-5-3-2-1- . . . -9-6-4-3-2 |
| 2 | 1-1-0-0 | 11-10-9-8 | 11-10-4- . . . - 6-5-3-2-1 - . . . -9- |
| | | | 6-4-3-2 |
| . . . | . . . | . . . | . . . |

To optimize area, 1 dword of a ‘y’ buffer is written directly to the register API. The sample buffer 405 generates a valid signal after accumulating 1 dword worth of data which can be used as a write enable for the register API. To protect the signature from intermittent firmware reads, the signature register is lockable. The lock is asserted during signing flow and is only unlocked after the entire flow has been completed.

On every cycle of operation, the sample buffer 405 also outputs the number of non-zero coefficients for that polynomial. At the end of all polynomials, the hintsum is written to the register API to construct the y[ω+k−1:w] location of the byte string.

It is possible that during the last cycle of a given polynomial, the index buffer contains <1 dword of index values to be written to the reg API. To accommodate this scenario, the controller flushes out the buffer at the end of each polynomial and writes the remaining data to the register API.

The hint is used for at least two other operations. Those operations occur after some other events occur following calculation of the hint. In one example, the hint output is stored in memory for later use by the other operations. Instead of storing in memory, an improvement is to embed the hint in the signature by encoding H component into the signature as part of a MAKEHINT structure. Encoding the hint in this manner is performed every cycle that hints are computed and packed at the end of all the 256 coefficients and all the polynomials. This provides updated hints without having to recalculate or retrieve the hints from slower memory.

### Resource Sharing

To reconstruct a signer's commitment, it is necessary to update the approximate computed value labeled as w′ by utilizing the provided hint. Hence, the value of w′ should be decomposed, and its higher part should be altered if the related hint equals 1 for that coefficient. Subsequently, the higher part requires encoding through the W1Encode operation and must be stored into the Keccak serial in-parallel-out (SIPO) memory.

In signing operation, the signer's commitment is shown by w, which needs to be decomposed into two shares to provide the required hint as a part of signature. The output of decompose is shown by (w1, w0) which presents the higher and lower parts of the given input. While w0 can be stored into the memory, the value of w1 is required to compute commitment hash using SHAKE256 operation. The memory configuration stores 4 coefficients per address to achieve a high-performance architecture. 4 parallel cores are used for decompose and encode units to match the throughput between these modules.

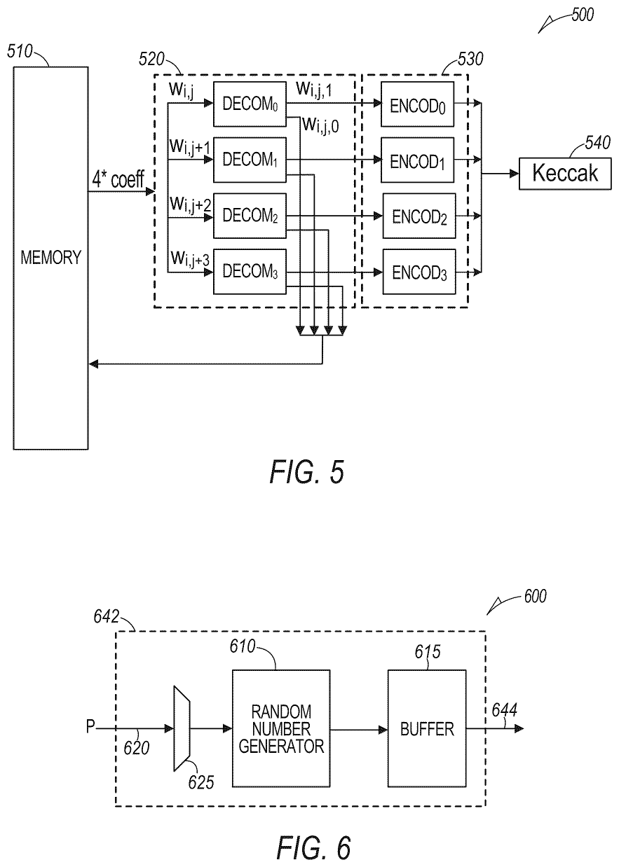

FIG. 5 is a block diagram of a Decompose and W1Encode system 500 used in signing operations. To construct a system that supports all required operations for ML-DSA, i.e., keygen, signing, and verifying, it would be beneficial to reuse some resources used in one operation in one or more of the other operations. Such resource reuse reduces the total resource utilization and results in higher efficiency.

In the verifying operation, a UseHint procedure is similar to the Decompose and W1Encode steps in the signing process, but it differs since there's no need to store the lower segment in memory. Moreover, the UseHint operation occurs between Decompose and W1Encode, adjusting the upper portion of the Decompose output utilizing h.

System 500 includes a memory 510 that stores polynomial coefficients and provides the coefficients to parallel decompose units 520. Outputs of the decompose units 520 are provided to corresponding parallel encode units 530 and to memory 510. Outputs of the encode units 530 are provided to a Keccak unit 540.

FIG. 6 is a block diagram of an example Keccak unit 600 corresponding to Keccak unit 540 for generating polynomial coefficients for lattice-based cryptographic systems. Keccak unit 600 includes a random number generator 610. A Keccak hash function may be used as random number generator 610. The random number generator 610 produces a random bit string that is stored in a buffer 615. Buffer 615 may be a parallel-in, serial-out (PISO) buffer in one example.

A seed, ρ 620, is provided via a multiplexer 625 to the random number generator 610. A new seed is provided for each polynomial. The buffer 615 in one example is not large enough to buffer the number of bits needed for system 600 to process the coefficients of an entire polynomial, so a loop path 630 is provided back to the multiplexer 625 to prompt the random generator 610 to provide a next number of bits of the bitstream to buffer 615 for a current polynomial until all the coefficients of the current polynomial are processed. In one example, the random number generator 610, buffer 615, multiplexer 625 and loop path 630 form a random number generator unit 642. The bits are provided from buffer 615 on an output 614 for use by various cryptographic units to perform key generation, signature generation, and signature verification.

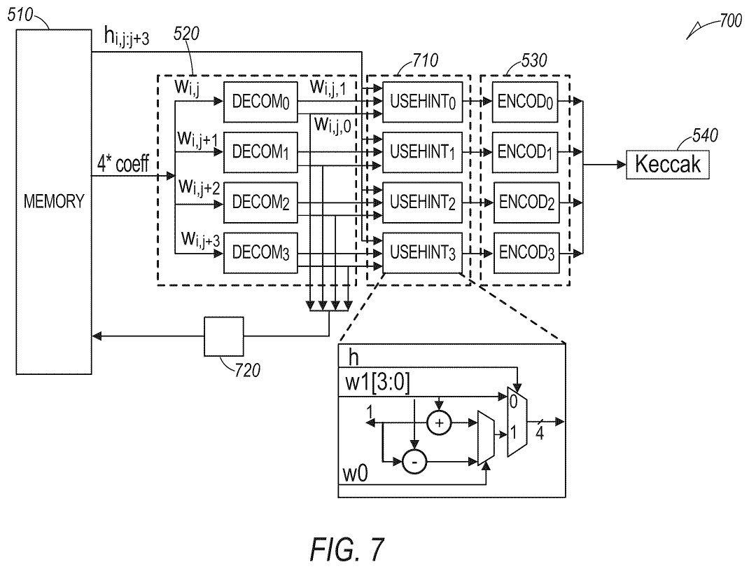

FIG. 7 is a block diagram of an improved system 700 that is configurable to perform both a signature verifying operation with parallel UseHint units 710. While performing signature verification, a controllable multiplexer or switch 720 is used to prevent writing of the output of the decompose units 520 to memory 510.

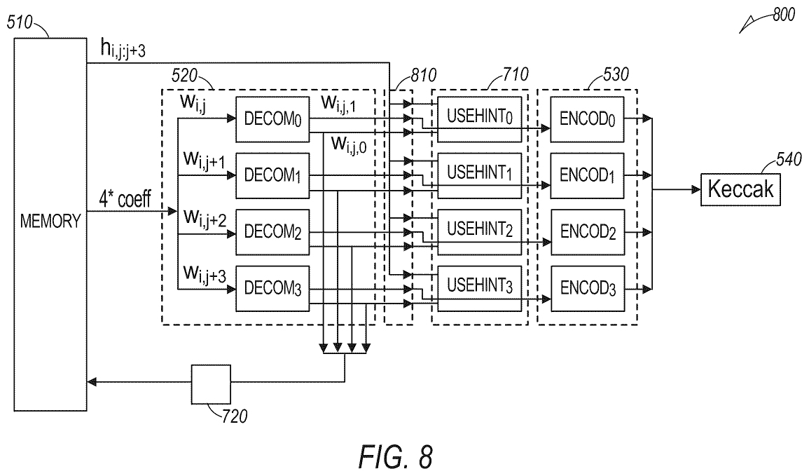

FIG. 8 is a block diagram of a system 800 for performing signing functions. System 800 is similar to system 700 but is configured via a multiplexor 810 for bypassing the UseHint units 710 such that system 800 operates in a manner similar to system 500. Switch 720 allows writing of decompose unit outputs to memory 510. System 800 can thus operate as both a signature generator and a signature verifier depending on control of multiplexer 810 and switch 710, sharing decompose and encode resources.

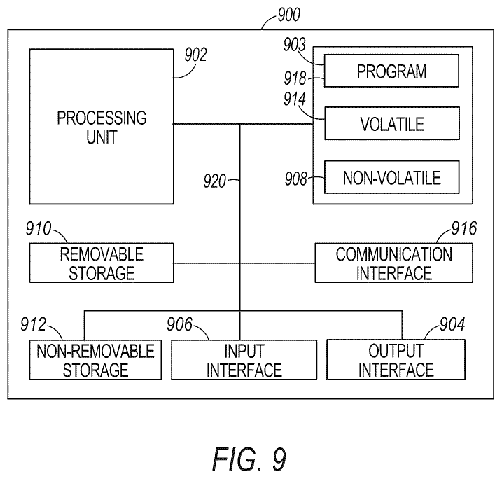

FIG. 9 is a block schematic diagram of a computer system 900 to . . . and for performing methods and algorithms according to example embodiments. All components need not be used in various embodiments.

One example computing device in the form of a computer 900 may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, smart storage device (SSD), or other computing device including the same or similar elements as illustrated and described with regard to FIG. 9. Devices, such as smartphones, tablets, and smartwatches, are generally collectively referred to as mobile devices or user equipment.

Although the various data storage elements are illustrated as part of the computer 900, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 903 may include volatile memory 914 and non-volatile memory 908. Computer 900 may include-or have access to a computing environment that includes-a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium are executable by the processing unit 902 of the computer 900, such as a program 918. The program 918 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 918 along with the workspace manager 922 may be used to cause processing unit 902 to perform one or more methods or algorithms described herein.

### Examples

1. A lattice-based cryptographic engine includes a MakeHint unit to generate hints for polynomial coefficients. Logic hardware is coupled to the MakeHint unit and includes a hint sum unit configured to add hints for coefficients of a polynomial, compare a hint sum to a threshold, and generate an invalid signal in response to the hint sum exceeding the threshold. The logic hardware also includes a sample buffer configured to receive the hints, a hint bitpack coupled to store indices of non-zero hints, and a controller coupled to control transfer of hints to output registers.

2. The engine of example 1 wherein the hints are encoded and embedded into a signature.

3. The engine of any of examples 1-2 and further including a memory storing the polynomial coefficients, decompose units coupled to receive coefficients from the memory to selectively provide output to the memory, and provide decomposed values, UseHint units selectively coupled to the decompose units, and encode units selectively coupled to the UseHint units or the decompose units.

4. The engine of example 3 and further including a multiplexer coupled between the decompose units and the UseHint units to alternately couple the decompose units to the encode units or couple the decompose units to the UseHint units and encode units.

5. The engine of any of examples 3-4 and further including a switch coupled between the decompose units and the memory.

6. The engine of any of examples 1-5 wherein the threshold is 75.

7. The engine of any of examples 1-6 wherein the MakeHint unit further includes a decompose unit coupled to decompose bits of a polynomial t of a Dilithium public key into lower bits and higher bits.

8. The engine of example 7 and further including a Hash and SampleInBall unit to perform a SampleInBall operation on the higher bits.

9. The engine of example 8 wherein the MakeHint unit includes parallel MakeHint function Units coupled to compare higher bits of polynomial t.

10. A lattice-based cryptographic engine including a MakeHint unit including a decompose unit to generate hints for polynomial coefficients, the decompose unit coupled to decompose received polynomial t into higher bits and lower bits. Logic hardware is coupled to the MakeHint unit and includes a hint sum unit configured to add hints for coefficients of a polynomial, compare a hint sum to a threshold, and generate an invalid signal in response to the hint sum exceeding the threshold, a sample buffer configured to receive the hints, a hint bitpack coupled to store indices of non-zero hints, and a controller coupled to control transfer of hints to output registers.

11. The engine of example 10 wherein the hints are encoded and embedded into a signature.

12. The engine of any of examples 10-11 and further including a memory storing the polynomial coefficients, decompose units coupled to receive coefficients from the memory to selectively provide output to the memory, and provide decomposed values, UseHint units selectively coupled to the decompose units, and encode units selectively coupled to the UseHint units or the decompose units.

13. The engine of example 12 and further comprising a multiplexer coupled between the decompose units and the UseHint units to alternately couple the decompose units to the encode units or couple the decompose units to the UseHint units and encode units.

14. The engine of any of examples 12-13 and further comprising a switch coupled between the decompose units and the memory.

15. The engine of any of examples 12-14 wherein the threshold is 75.

16. The engine of any of examples 10-15 and further including a Hash and SampleInBall unit to perform a SampleInBall operation on the higher bits.

17. The engine of example 16 wherein the MakeHint unit includes parallel MakeHint function Units coupled to compare higher bits of polynomial t.

18. A method includes generating hints for polynomial coefficients via a MakeHint unit of a lattice-based cryptographic engine, adding hints, via hint sum unit logic hardware coupled to the MakeHint unit, for coefficients of a polynomial, comparing a hint sum to a threshold, generating an invalid signal in response to the hint sum exceeding the threshold, storing indices of non-zero hints via a hint bitpack unit, and transferring the hints to an output register.

19. The method of example 18 and further including encoding the hints into a signature.

20. The method of any of examples 18-19 and further including storing the polynomial coefficients, decomposing the polynomial coefficients via decompose units to selectively provide output to a memory, and provide decomposed values, selectively coupling UseHint units to the decompose units, and selectively coupling encode units to the UseHint units or the decompose units.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A lattice-based cryptographic engine comprising:
a MakeHint unit to generate hints for polynomial coefficients; and
logic hardware coupled to the MakeHint unit, the logic hardware comprising:
a hint sum unit configured to add hints for coefficients of a polynomial, compare a hint sum to a threshold, and generate an invalid signal in response to the hint sum exceeding the threshold;
a sample buffer configured to receive the hints;
a hint bitpack coupled to store indices of non-zero hints; and
a controller coupled to control transfer of hints to output registers.

2. The engine of claim 1 wherein the hints are encoded and embedded into a signature.

3. The engine of claim 1 and further comprising:
a memory storing the polynomial coefficients;
decompose units coupled to receive coefficients from the memory to selectively provide output to the memory, and provide decomposed values;
UseHint units selectively coupled to the decompose units; and
encode units selectively coupled to the UseHint units or the decompose units.

4. The engine of claim 3 and further comprising a multiplexer coupled between the decompose units and the UseHint units to alternately couple the decompose units to the encode units or couple the decompose units to the UseHint units and encode units.

5. The engine of claim 3 and further comprising a switch coupled between the decompose units and the memory.

6. The engine of claim 1 wherein the threshold is 75.

7. The engine of claim 1 wherein the MakeHint unit further comprises a decompose unit coupled to decompose bits of a polynomial t of a Dilithium public key into lower bits and higher bits.

8. The engine of claim 7 and further comprising a Hash and SampleInBall unit to perform a SampleInBall operation on the higher bits.

9. The engine of claim 8 wherein the MakeHint unit includes parallel MakeHint function Units coupled to compare higher bits of polynomial t.

10. A lattice-based cryptographic engine comprising:
a MakeHint unit including a decompose unit to generate hints for polynomial coefficients, the decompose unit coupled to decompose received polynomial t into higher bits and lower bits;
logic hardware coupled to the MakeHint unit, the logic hardware comprising:
a hint sum unit configured to add hints for coefficients of a polynomial, compare a hint sum to a threshold, and generate an invalid signal in response to the hint sum exceeding the threshold;
a sample buffer configured to receive the hints;
a hint bitpack coupled to store indices of non-zero hints; and
a controller coupled to control transfer of hints to output registers.

11. The engine of claim 10 wherein the hints are encoded and embedded into a signature.

12. The engine of claim 10 and further comprising:
a memory storing the polynomial coefficients;
decompose units coupled to receive coefficients from the memory to selectively provide output to the memory, and provide decomposed values;
UseHint units selectively coupled to the decompose units; and
encode units selectively coupled to the UseHint units or the decompose units.

13. The engine of claim 12 and further comprising a multiplexer coupled between the decompose units and the UseHint units to alternately couple the decompose units to the encode units or couple the decompose units to the UseHint units and encode units.

14. The engine of claim 12 and further comprising a switch coupled between the decompose units and the memory.

15. The engine of claim 12 wherein the threshold is 75.

16. The engine of claim 10 and further comprising a Hash and SampleInBall unit to perform a SampleInBall operation on the higher bits.

17. The engine of claim 16 wherein the MakeHint unit includes parallel MakeHint function Units coupled to compare higher bits of polynomial t.

18. A method comprising:
generating hints for polynomial coefficients via a MakeHint unit of a lattice-based cryptographic engine;
adding hints, via hint sum unit logic hardware coupled to the MakeHint unit, for coefficients of a polynomial;
comparing a hint sum to a threshold;
generating an invalid signal in response to the hint sum exceeding the threshold;
storing indices of non-zero hints via a hint bitpack unit; and
transferring the hints to an output register.

19. The method of claim 18 and further comprising encoding the hints into a signature.

20. The method of claim 18 and further comprising:
storing the polynomial coefficients;
decomposing the polynomial coefficients via decompose units to selectively provide output to a memory, and provide decomposed values;
selectively coupling UseHint units to the decompose units; and
selectively coupling encode units to the UseHint units or the decompose units.
